(19) United States
(12) Patent Application Publication
(10) Pub. No.: US 2008/0294561 A1
(43) Pub. Date: Nov. 27, 2008

(54) Media content deciphered when initiated for playback

(75) Inventor: John H. Grossman, Fremont, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/805,089

(22) Filed: May 22, 2007

(51) Int. Cl. H04K 1/00

(52) U.S. Cl. 705/51

(57) ABSTRACT

Media content being deciphered when initiated for playback is described. In embodiment(s), encrypted media content can be received from a content distributor without deciphering the encryption that is applied by the content distributor. Optionally, the encrypted media content can also be recorded without deciphering the applied encryption. The encrypted media content can be initiated for viewing or playback from the recording, and at that time, the credentials to decipher the encrypted media content can be obtained, such as from the content distributor. The encrypted media content can then be decipher with the credentials such that the media content can be rendered for viewing.

### BACKGROUND

In a subscription television system, media content such as audio and video data for television programs, movies, music and the like is encrypted at a content provider and/or content distributor for distribution to subscribers. Television client devices receive the encrypted media content and decipher it as it is being received to process and/or record the media content without encryption. For example, the media content can be received and recorded in a pause buffer for a television channel that is currently being rendered for viewing, or the media content can be recorded and stored for playback when convenient for a viewer.

Generally, it is expected that the media content is secure when encrypted and delivered to a television client device which can then decipher the media content. However, the media content is not secure from unauthorized copying or content theft when it is deciphered at a television client device. An attacker can hack into the device to modify the policies for handling the deciphered media content. Additionally, the media content is vulnerable to an attack from anyone with control of the client application while it is held within client memory, and hacking is only one example of how the media content may be susceptible to unauthorized copying or content theft. For example, a corrupt developer may gain control of a client application and have access to the media content without hacking into the client device. An attacker or corrupt developer can then divert where and/or how the media content is recorded to make unauthorized copies of movies, on-demand media content, and other television programming.

### SUMMARY

This summary is provided to introduce simplified concepts of media content being deciphered when initiated for playback. The simplified concepts are further described below in the Detailed Description. This summary is not intended to identify essential features of the claimed subject matter, nor is it intended for use in determining the scope of the claimed subject matter.

In an embodiment, encrypted media content can be received from a content distributor without deciphering the encryption that is applied by the content distributor. When the encrypted media content is initiated for playback, the credentials to decipher the encrypted media content can be obtained, such as from the content distributor or from a credentials service. The encrypted media content can then be deciphered with the credentials such that the media content can be decoded and rendered for viewing.

In other embodiment(s), encrypted media content can be received from a content distributor and the media content can then be recorded without deciphering the encryption that is applied by the content distributor. The encrypted media content can be initiated for playback from the recording, and at that time, the credentials to decipher the encrypted media content can be obtained, such as from the content distributor. The encrypted media content can then be deciphered with the credentials such that the media content can be decoded and rendered for viewing.

In other embodiment(s), encrypted media content received from a content distributor can be recorded without having rights established to playback the recording of the encrypted media content, such as a recording from a television channel that a subscriber does not have the rights to view. The rights to playback the recording of the encrypted media content can be negotiated with the content distributor, such as purchasing the rights to playback the recording. The recorded media content can then be deciphered with credentials obtained from the content distributor such that the media content can be decoded and rendered for viewing.

In other embodiment(s), a media content system includes a recording device that records the encrypted media content when received from the content distributor. The system also includes a content rendering device that is communicatively linked to the recording device. The recording device can record and maintain the encrypted media content for the content rendering device without any rights to render the encrypted media content. The content rendering device can then receive the encrypted media content from the recording device to initiate playback of the encrypted media content. A decipher module within the content rendering device can then obtain the credentials to decipher the encrypted media content when received at the content rendering device for playback.

### BRIEF DESCRIPTION OF THE DRAWINGS

Embodiments of media content being deciphered when initiated for playback are described with reference to the following drawings. The same numbers are used throughout the drawings to reference like features and components:

FIG. 1 illustrates an example system in which embodiments of media content being deciphered when initiated for playback can be implemented.

FIG. 2 illustrates another example system in which embodiments of media content being deciphered when initiated for playback can be implemented.

FIG. 3 illustrates example method(s) of media content being deciphered when initiated for playback in accordance with one or more embodiments.

FIG. 4 illustrates various components of an example client device which can implement embodiments of media content being deciphered when initiated for playback.

FIG. 5 illustrates various devices and components in an example entertainment and information system in which embodiments of media content being deciphered when initiated for playback can be implemented.

### DETAILED DESCRIPTION

Embodiments of media content being deciphered when initiated for playback provide that a content rendering device, such as a television client device, can receive and/or record encrypted media content without deciphering or otherwise removing the encryption applied by a content distributor. Rather, the encrypted media content can be deciphered after being initiated for playback. The encrypted media content can be received and processed without removing the encryption, and then deciphered just before decoding and displaying the media content. This provides that the encrypted media content can be received and/or recorded without having the rights to playback the media content, such as a recording from a subscription television channel that a subscriber has not paid to view. The rights to view the media content can be negotiated when the recording of the encrypted media content is initiated for playback and viewing.

Further, a connected storage and recording device can record and maintain the encrypted media content for the content rendering device without any rights to playback the encrypted media content. For example, a recording device can record television programs for a television client device, or record video data for a gaming system that has limited storage capacity. The recorded media content can be stored as originally encrypted by a content distributor, and only then be deciphered by the content rendering device when the encrypted media content is received from the connected storage and recording device.

While features and concepts of the described systems and methods for media content being deciphered when initiated for playback can be implemented in any number of different environments, computing systems, entertainment systems, and/or other various configurations, embodiments of media content being deciphered when initiated for playback are described in the context of the following example systems and environments.

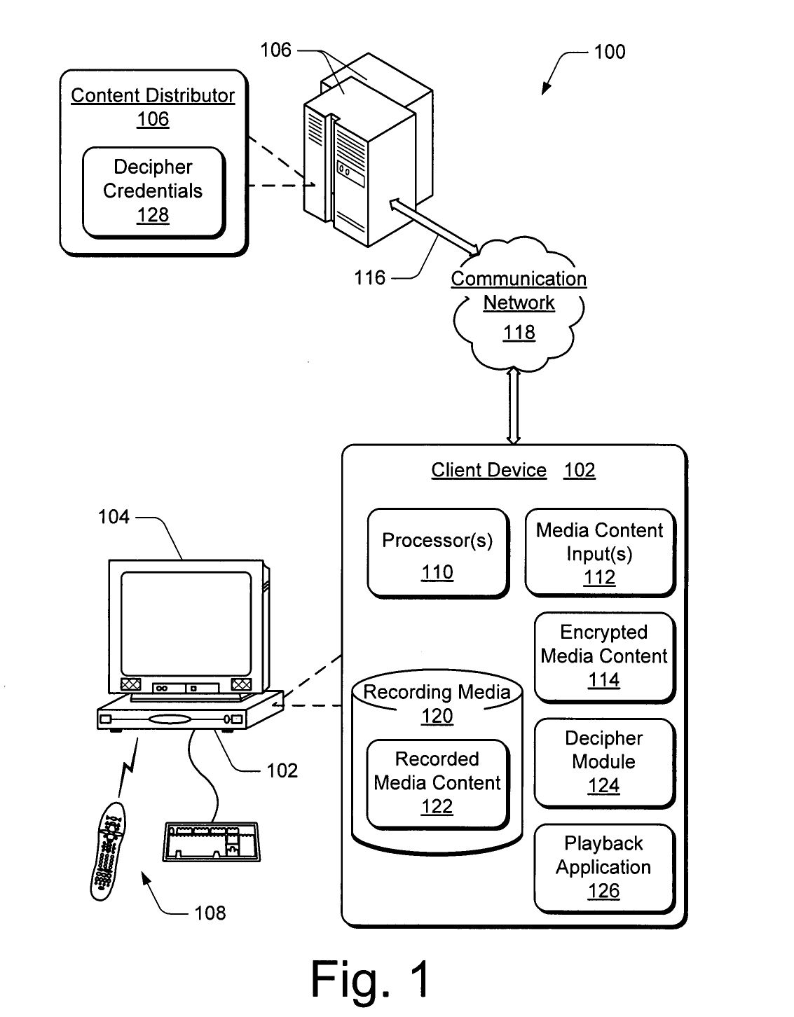

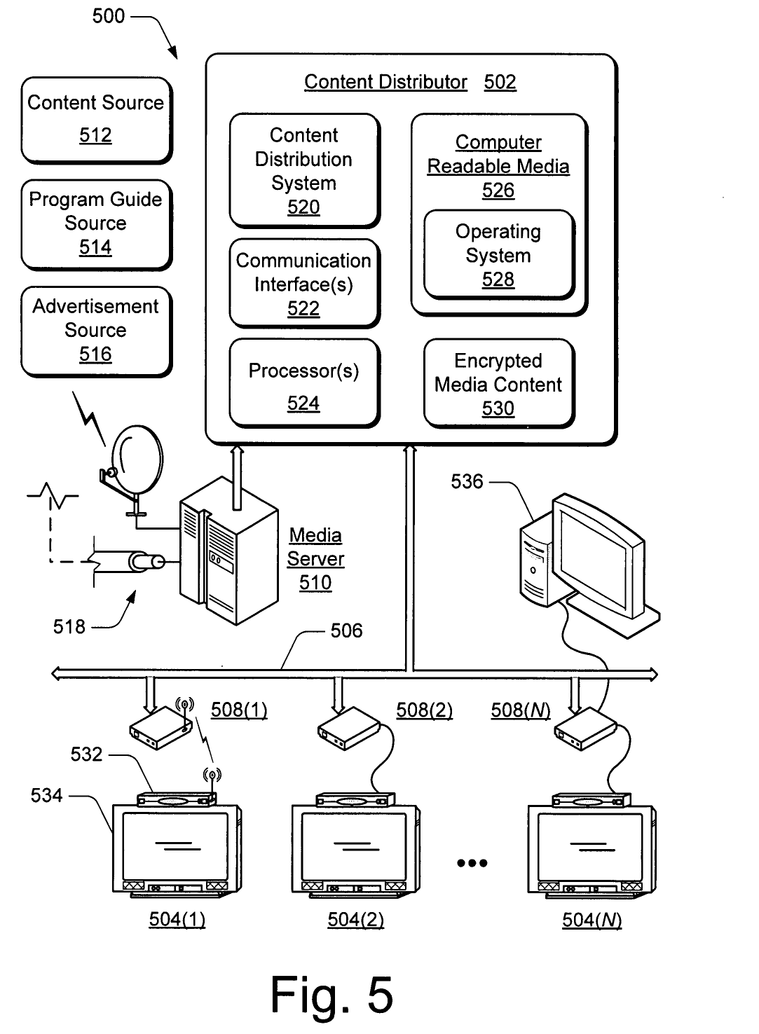

FIG. 1 illustrates an example system 100 in which various embodiments of media content being deciphered when initiated for playback can be implemented. In this example, system 100 includes a television client device 102, a display device 104, content distributor(s) 106, and input devices 108, such as a remote control device and/or a computer keyboard. The display device 104 can be implemented as any type of television, LCD, or similar television-based display system that renders audio, video, and/or image data. The client device 102 and display device 104 together are just one example of a television client system, examples of which are described with reference to the example entertainment and information system shown in FIG. 5.

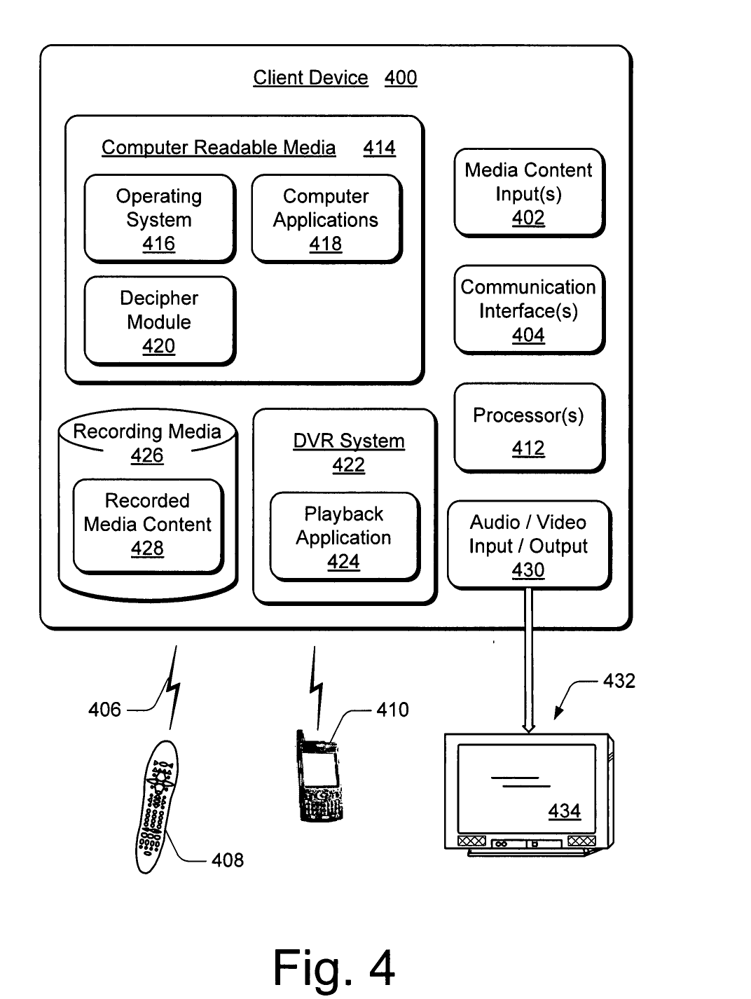

Client device 102 can be implemented as any one or combination of a television set-top box, a digital video recorder (DVR) and playback system, an appliance device, a gaming console, and/or as any other type of television client device or computing-based device that may be implemented in a television entertainment and information system. Additionally, client device 102 can be implemented with any number and combination of differing components as further described with reference to the example client device shown in FIG. 4.

In this example system 100, client device 102 includes one or more processor(s) 110, media content inputs 112, and encrypted media content 114. The media content inputs 112 can include any type of Internet Protocol (IP) inputs over which streams of media content (e.g., IPTV media content, encrypted media content, etc.) are received via an IP-based network 116. Client device 102 can receive the encrypted media content 114 from content distributor(s) 106 via the IP-based network 116. The encrypted media content 114 can include IPTV media content or any other type of media content that is being received or has been received.

In an embodiment, the encrypted media content 114 is encrypted MPEG data having any one or combination of an encrypted elementary stream or data layer, an encrypted systems layer, and/or an encrypted transport layer. Further, embodiments of media content being deciphered when initiated for playback can be implemented for any type of transport layer or system, communication channel, active data link, and the like in which the media content is received and/or recorded while still encrypted.

The IP-based network 116 can be implemented as part of a communication network 118 that facilitates media content distribution and data communication between the content distributor(s) 106 and any number of client devices, such as client device 102. The communication network 118 can be implemented as part of a media content distribution system using any type of network topology and/or communication protocol, and can be represented or otherwise implemented as a combination of two or more networks. The television client device 102 is configured for communication with the content distributor(s) 106 via the communication network 118 to receive media content, such as the encrypted media content 114.

Client device 102 also includes recording media 120 that maintains recorded media content 122. In an embodiment, the recorded media content 122 can include encrypted media content 114 that is received from a content distributor 106 and recorded. Further, the encrypted media content 114 can be recorded without deciphering it so that the encryption applied to the media content at the content distributor 106 is maintained. For example, the encrypted media content 114 can be recorded when received as a viewer-scheduled recording, or when the recording media 120 is a pause buffer that records the encrypted media content 114 as it is being received and rendered for viewing. The encrypted media content 114 can be maintained as encrypted until just before playback to prevent content theft and/or unauthorized recordings.

Media content, the encrypted media content 114, and/or the recorded media content 122 can include television programs (or programming) which may be any form of programs, commercials, music, movies, and video on-demand media content. Other media content can include interactive games, network-based applications, music streamed from a computing device to the client device 102, as well as any other audio, video, and/or image content received from any type of media content source.

Client device 102 includes a decipher module 124 (also referred to as a “crypto core”) that can be implemented to decipher the encrypted media content 114. In an embodiment, the decipher module 124 can be implemented as computer-executable instructions and executed by the processor(s) 110 to implement embodiments of media content being deciphered when initiated for playback.

In one or more embodiments, the encrypted media content 114 can be received and/or recorded (e.g., recorded media content 122) without deciphering it so that the encryption applied to the media content at the content distributor 106 is maintained. For purposes of the following description, the recorded media content 122 is encrypted media content that has been recorded, or “recorded encrypted media content”. A playback application 126 can initiate playback of the encrypted media content that is recorded, such as when a viewer at client device 102 selects to watch a recorded program. When the recorded media content 122 is initiated for playback, the playback application 126 can communicate a request to the decipher module 124 to decipher the recorded media content 122 so that it can be rendered for viewing.

The decipher module 124 can receive the request from the playback application 126 and request credentials to decipher the encrypted media content that has been recorded. In an embodiment, the decipher module 124 can request decipher credentials 128 from a content distributor 106. The decipher credentials 128 can include any type of authorization to access and decipher the encrypted media content, such as decryption keys.

In one embodiment, the decipher module 124 can receive the decipher credentials 128 from a content distributor 106 and decipher the recorded media content 122. In an alternate embodiment, the decipher module 124 can receive the decipher credentials 128 and communicate them to the playback application 126 that then deciphers the recorded media content 122. In this example, the client device 102 is implemented such that the playback application 126 is restricted from obtaining the decipher credentials 128 directly from the content distributor 106.

In this example system 100, the decipher module 124 can be implemented as a software component, a hardware component, or as a combination thereof. When implemented as a hardware component, the decipher module 124 is secure from software attacks and/or configuration modifications that would allow the encrypted media content 114 to be deciphered without first obtaining the decipher credentials 128.

Implementing the decipher module 124 allows for a partitioned client implementation of the security or crypto core within the television client device 102. Whether or not the encrypted media content 114 is recorded or rendered for viewing when received, deciphering the encrypted media content at the later stage during the audio/visual processing provides that the client device itself can be compromised by an attacker without reducing the ability to secure the encrypted media content. The attack “surface area” of the client device 102 is reduced to that of the security core (e.g., the decipher module 124) and the subsequent stages of the audio/visual processing pipeline. This represents a vast reduction in the attack surface area of the media content distribution system as a whole. The decipher module 124 provides another level of security for the valuable plaintext audio/visual data and encryption keys in the media content distribution system.

In an embodiment, the encrypted media content 114 can be received and recorded without the client device 102 having rights established to playback the recorded media content 122. For example, a viewer at client device 102 may schedule a recording of a program on a channel that the viewer does not subscribe to or pay for. Because the encrypted media content 114 is recorded while still being encrypted as it is received from the content distributor 106, the viewer can not watch the program until the decipher credentials 128 are obtained. For example, the viewer can initiate that the playback application 126 negotiate with the content distributor 106 to establish the rights to playback the recorded media content 122. Negotiating with the content distributor 106 may include purchasing the rights to view the recorded program, such as on a per-program basis or by subscribing to the channel.

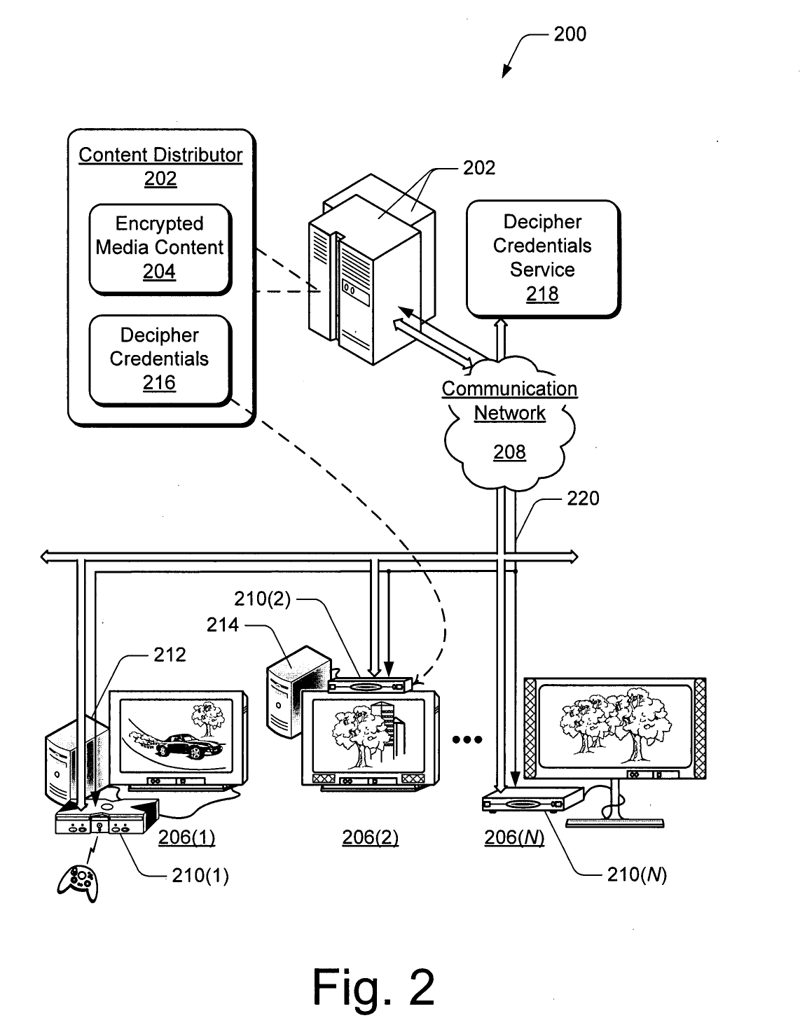

FIG. 2 illustrates another example system 200 in which various embodiments of media content being deciphered when initiated for playback can be implemented. The system 200 includes content distributor(s) 202 that communicate encrypted media content 204 to any number “N” of various television client systems 206(1-N) via a communication network 208. An example of a communication network is described with reference to communication network 118, and examples of client devices in television client systems are described with reference to television client device 102 as shown in FIG. 1. The communication network 208 can be implemented to include an IP-based network that facilitates media content distribution and data communication between the content distributor(s) 202 and any number of television client devices.

Each of the client systems 206(1-N) include a respective television client device 210(1-N) and a display device, such as any type of television, monitor, LCD, or similar television-based display system that renders audio, video, and/or image data. Any of the client devices 210(1-N) can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device. Any of the television client devices 210(1-N) may also be associated with a user (i.e., a person) and/or an entity that operates a client device such that a television client device describes logical clients that include users, software, and/or devices.

Any of the television client devices 210(1-N) of the respective client systems 206(1-N) can be implemented with one or more processors, a communication module, memory components, and a media content rendering system. Additionally, each of the television client devices 210(1-N) can be configured for communication with any number of different content distributors to receive any type of media content via the communication network 208. Further, any of the television client devices 210(1-N) can be implemented with any number and combination of differing components as further described with reference to the example client device shown in FIG. 4.

In this example, client device 210(1) is a gaming system that is connected, or otherwise communicatively linked, to a storage and recording device 212. The recording device 212 can be implemented as any type of electronic or computing-based device having recording media to store encrypted media content 204 for a client device. For example, recording device 212 can store any type of encrypted video, audio, and/or image data for video games that are rendered for viewing by the client device 210(1).

The encrypted data for the video games is maintained in the recording device 212 as received from a content distributor 202. As such, encrypted media content 204 can be stored on any device and then requested for playback. For example, the client device 210(1) can receive the encrypted video game data from the connected storage and recording device 212 to initiate rendering the data. A decipher module of client device 210(1) (such as decipher module 124 shown in FIG. 1) can then request and obtain the decipher credentials 216 from the content distributor 202 to decipher the encrypted video game data. In an alternate embodiment, the decipher credentials can be obtained from an independent decipher credentials service 218.

In another example, client device 210(2) is a television set-top box that is connected, or otherwise communicatively linked, to a storage and recording device 214. The recording device 214 can be implemented as any type of electronic or computing-based device having recording media to store encrypted media content 204 for the client device 210(2). For example, recording device 214 can store any type of encrypted video, audio, and/or image data for television programs that are rendered for viewing by the television client device 210(2).

The encrypted television program data is maintained in the recording device 214 as received from a content distributor 202. Because the television program data is encrypted, it can be stored on any device and then requested for playback. For example, the television client device 210(2) can receive the encrypted television program data from the connected recording device 214 to initiate rendering the television program for viewing. A decipher module of the television client device 210(2) (such as decipher module 124 shown in FIG. 1) can then request and obtain the decipher credentials 216 from the content distributor 202 to decipher the encrypted television program. In an alternate embodiment, the decipher credentials can be obtained from the independent decipher credentials service 218.

The client device 210(1) and/or the television client device 210(2) can receive the decipher credentials 216 from the content distributor 202 or from the decipher credentials service 218 via the communication network 208 or via a two-way data communication link 220 of the communication network 208. It is contemplated that any one or more of the arrowed communication links 220 along with communication network 208 facilitate two-way data communication, such as from a client system 206(2) to a content distributor 202 and vice-versa.

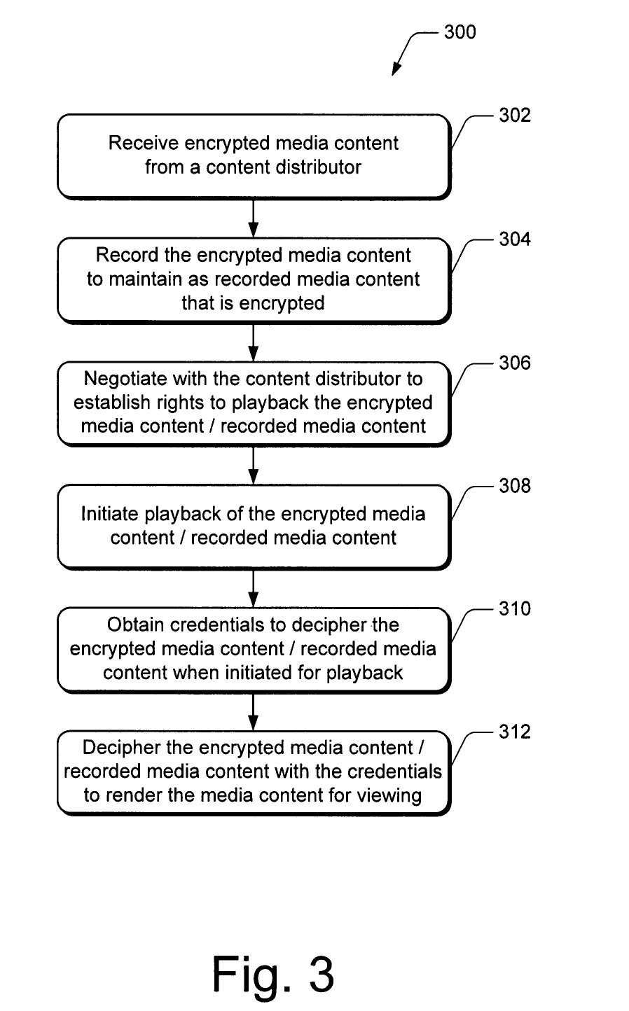

Generally, any of the functions, methods, and modules described herein can be implemented using hardware, software, firmware (e.g., fixed logic circuitry), manual processing, or any combination thereof. A software implementation of a function, method, or module represents program code that performs specified tasks when executed on a computing-based processor. Example method 300 described with reference to FIG. 3 may be described in the general context of computer-executable instructions. Generally, computer-executable instructions can include applications, routines, programs, objects, components, data structures, procedures, modules, functions, and the like that perform particular functions or implement particular abstract data types. The method(s) may also be practiced in a distributed computing environment where functions are performed by remote processing devices that are linked through a communications network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of media content being deciphered when initiated for playback. The order in which the method is described is not intended to be construed as a limitation, and any number of the described method blocks can be combined in any order to implement the method, or an alternate method.

At block 302, encrypted media content is received from a content distributor. For example, client device 102 receives encrypted media content 114 from one or more content distributors 106 via a communication network 118. In an embodiment, the encrypted media content 114 is encrypted MPEG data having any one or combination of an encrypted data layer, an encrypted systems layer, and/or an encrypted transport layer.

At block 304, the encrypted media content is optionally recorded and maintained as recorded media content that is encrypted. For example, the encrypted media content 114 is recorded without deciphering it so that the encryption applied to the media content at the content distributor 106 is maintained. The encrypted media content 114 can be recorded when received as a viewer-scheduled recording, or when recorded in a pause buffer that records the encrypted media content 114 as it is being received and rendered for viewing. Further, the encrypted media content 114 can be received and recorded without the client device 102 having rights established to playback the recorded media content 122, such as when recording a television channel that a subscriber does not have rights to view.

At block 306, the content distributor is negotiated with to establish rights to playback the encrypted media content or recorded media content. For example, in an event that the encrypted media content 114 is recorded without viewing rights (e.g., as recorded media content 122), the playback application 126 negotiates with the content distributor 106 to establish the rights to playback the recorded media content 122. The playback application 126 negotiates the rights when the recorded media content is initiated for playback, or just before. Negotiating with the content distributor 106 may include purchasing the rights to view the recorded program, such as on a per-program basis or by subscribing to the channel from which the program was recorded.

At block 308, playback of the encrypted media content or recorded media content is initiated. For example, playback application 126 initiates playback of the encrypted media content 114 or the encrypted media content that is recorded, such as when a viewer at client device 102 selects to watch a recorded program.

At block 310, credentials to decipher the encrypted media content or recorded media content are obtained when initiated for playback. For example, playback application 126 communicates a request to the decipher module 124 to decipher the encrypted media content 114 or the recorded media content 122 so that it can be rendered for viewing. The decipher module 124 receives the request from the playback application 126 and requests credentials to decipher the encrypted media content or the encrypted media content that is recorded. In an embodiment, the credentials to decipher the recorded media content can be obtained from the content distributor 106. Alternatively, the decipher credentials can be obtained from a credentials service 218.

At block 312, the encrypted media content or recorded media content is deciphered with the credentials such that the media content can be rendered for viewing. For example, the decipher module 124 receives the decipher credentials 128 from content distributor 106 and deciphers the encrypted media content 114 or the recorded media content 122. In an alternate embodiment, the decipher module 124 receives the decipher credentials 128 and communicates them to the playback application 126 that then deciphers the encrypted media content 114 or the recorded media content 122.

FIG. 4 illustrates various components of an example client device 400 that can be implemented as any form of a computing, electronic, or television client device to implement embodiments of media content being deciphered when initiated for playback. For example, client device 400 can be implemented as client device 102 shown in FIG. 1, and/or as any of the client devices 210(1-N) of the client systems 206(1-N) shown in FIG. 2. In various embodiments, client device 400 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Client device 400 includes one or more media content inputs 402 that may include Internet Protocol (IP) inputs over which streams of media content are received via an IP-based network. Client device 400 further includes communication interface(s) 404 that can be implemented as any one or more of a serial and/or parallel interface, a wireless interface, any type of network interface, a modem, and as any other type of communication interface. A wireless interface enables client device 400 to receive control input commands 406 and other information from an input device, such as from remote control device 408, a portable computing-based device (such as a cellular phone) 410, or from another infrared (IR), 802.11, Bluetooth, or similar RF input device.

A network interface provides a connection between client device 400 and a communication network by which other electronic and computing devices can communicate data with device 400. Similarly, a serial and/or parallel interface provides for data communication directly between client device 400 and the other electronic or computing devices. A modem facilitates client device 400 communication with other electronic and computing devices via a conventional telephone line, a DSL connection, cable, and/or other type of connection.

Client device 400 also includes one or more processors 412 (e.g., any of microprocessors, controllers, and the like) which process various computer-executable instructions to control the operation of device 400, to communicate with other electronic and computing devices, and to implement embodiments of media content being deciphered when initiated for playback. Client device 400 can be implemented with computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 414 provides data storage mechanisms to store various information and/or data such as software applications and any other types of information and data related to operational aspects of client device 400. For example, an operating system 416 and/or other computer applications 418 can be maintained as software applications with the computer-readable media 414 and executed on processor(s) 412 to implement embodiments of media content being deciphered when initiated for playback. For example, client device 400 can include a decipher module 420 (shown as a software module in this example) to implement various embodiments of media content being deciphered when initiated for playback as described herein.

Client device 400 can also include a DVR system 422 with playback application 424, and recording media 426 to maintain recorded media content 428 that client device 400 receives and/or records. In an embodiment, the recorded media content 428 is encrypted media content that is recorded as received from a content distributor. Further, client device 400 may access or receive additional recorded media content that is maintained with a remote data store (not shown). Client device 400 may also receive media content from a video-on-demand server, or media content that is maintained at a broadcast center or content distributor that distributes the media content to subscriber sites and client devices. The playback application 424 is a video control application that can be implemented to control the playback of media content, the recorded media content 428, and/or other video on-demand media content, music, and any other audio, video, and/or image media content which can be rendered/or displayed for viewing.

Client device 400 also includes an audio and/or video output 430 that provides audio and/or video data to an audio rendering and/or display system 432. The audio rendering and/or display system 432 can include any devices that process, display, and/or otherwise render audio, video, and image data. Video signals and audio signals can be communicated from client device 400 to a display device 434 via an RF (radio frequency) link, S-video link, composite video link, component video link, DVI (digital video interface), analog audio connection, or other similar communication link. Alternatively, the audio rendering and/or display system 432 can be implemented as integrated components of the example client device 400.

FIG. 5 illustrates an example entertainment and information system in which embodiments of media content being deciphered when initiated for playback can be implemented. System 500 facilitates the distribution of media content (e.g., encrypted media content), program guide data, and advertising content to multiple viewers and to multiple viewing systems. System 500 includes a content distributor 502 and any number “N” of client systems 504(1-N) each configured for communication via a communication network 506. Each client system 504(1-N) is an example of the client systems 206(1-N) described with reference to FIG. 2. Each of the client systems 504(1-N) can receive data streams of media content, program content, program guide data, advertising content, closed captions data, and the like from content server(s) of the content distributor 502 via the communication network 506.

The communication network 506 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 506 can be implemented using any type of network topology and any network communication protocol, and can be represented or otherwise implemented as a combination of two or more networks. A digital network can include various hardwired and/or wireless links 508(1-N), routers, gateways, and so on to facilitate communication between content distributor 502 and the client systems 504(1-N).

System 500 includes a media server 510 that receives media content from a content source 512, program guide data from a program guide source 514, and advertising content from an advertisement source 516. In an embodiment, the media server 510 represents an acquisition server that receives the audio and video media content from content source 512, an EPG server that receives the program guide data from program guide source 514, and/or an advertising management server that receives the advertising content from the advertisement source 516.

The content source 512, the program guide source 514, and the advertisement source 516 control distribution of the media content, the program guide data, and the advertising content to the media server 510 and/or to other servers. The media content, program guide data, and advertising content can be distributed via various transmission media 518, such as satellite transmission, radio frequency transmission, cable transmission, and/or via any number of other wired or wireless transmission media. In this example, media server 510 is shown as an independent component of system 500 that communicates the program content, program guide data, and advertising content to content distributor 502. In an alternate implementation, media server 510 can be implemented as a component of content distributor 502.

Content distributor 502 is representative of a headend service in a content distribution system, for example, that provides the media content, program guide data, and advertising content to multiple subscribers (e.g., the client systems 504(1-N)). The content distributor 502 can be implemented as a satellite operator, a network television operator, a cable operator, and the like to control distribution of media content, program and advertising content, such as movies, television programs, commercials, music, and other audio, video, and/or image content to the client systems 504(1-N).

Content distributor 502 includes various content distribution components of a content distribution system 520 to facilitate media content processing and distribution, such as a subscriber manager, a device monitor, and one or more content servers. The subscriber manager manages subscriber data, and the device monitor monitors the client systems 504(1-N) (e.g., and the subscribers), and maintains monitored client state information.

Although the various managers, servers, and monitors of content distributor 502 (to include the media server 510 in one embodiment) are described as distributed, independent components of content distributor 502, any one or more of the managers, servers, and monitors can be implemented together as a multi-functional component of content distributor 502. Additionally, any one or more of the managers, servers, and monitors described with reference to system 500 can implement features and embodiments of media content being deciphered when initiated for playback.

The content distributor 502 includes communication interface(s) 522 that can be implemented as any type of interface to communicate and receive data from client devices of the television system. The content distributor 502 also includes one or more processors 524 (e.g., any of microprocessors, controllers, and the like) which process various computer-executable instructions to control the operation of content distributor 502. The content distributor 502 can be implemented with computer-readable media 526 which provides data storage to maintain software applications such as an operating system 528 and encrypted media content 530 for distribution to the client systems 504(1-N).

The client systems 504(1-N) can each be implemented to include a client device 532 and a display device 534 (e.g., a television, LCD, and the like). A client device 532 of a respective client system 504 can be implemented in any number of embodiments, such as a set-top box, a digital video recorder (DVR) and playback system, an appliance device, a gaming system, and as any other type of client device that may be implemented in an entertainment and information system. In an alternate embodiment, client system 504(N) is implemented with a computing device 536 as well as a client device. The computing device 536 is an example of a connected data store that can record and maintain encrypted media content for a client device. Additionally, any client device 532 of a client system 504 can implement features and embodiments of media content being deciphered when initiated for playback as described herein.

Although embodiments of media content deciphered when initiated for a playback have been described in language specific to features and/or methods, it is to be understood that the subject of the appended claims is not necessarily limited to the specific features or methods described. Rather, the specific features and methods are disclosed as example implementations of media content being deciphered when initiated for playback.

1. A method, comprising:
receiving encrypted media content from a content distributor;
initiating playback of the encrypted media content;
obtaining credentials to decipher the encrypted media content when said initiating playback of the encrypted media content; and
deciphering the encrypted media content with the credentials such that the encrypted media content can be rendered for viewing.

2. A method as recited in claim 1, further comprising recording the encrypted media content to be maintained as recorded media content that is encrypted as received from the content distributor.

3. A method as recited in claim 2, wherein the encrypted media content is recorded without deciphering the encrypted media content as applied by the content distributor.

4. A method as recited in claim 2, wherein the encrypted media content is recorded from a television channel that a subscriber does not have rights to view.

5. A method as recited in claim 1, wherein the encrypted media content is received without having rights established to render the encrypted media content.

6. A method as recited in claim 1, wherein the credentials to decipher the recorded media content are obtained from the content distributor.

7. A method as recited in claim 1, wherein the encrypted media content is MPEG data received having an encrypted elementary stream.

8. A method as recited in claim 1, further comprising negotiating with the content distributor to establish rights to playback the recorded media content when the recorded media content is initiated for playback.

9. A television client device, comprising:
a recording media configured to record encrypted media content received from a content distributor;
a playback application configured to initiate playback of the encrypted media content that is recorded; and
a decipher module configured to:
receive a request from the playback application to decipher the encrypted media content; and
obtain credentials to decipher the encrypted media content for playback.

10. A television client device as recited in claim 9, wherein the recording media is further configured to record the encrypted media content without deciphering the encrypted media content as applied by the content distributor.

11. A television client device as recited in claim 9, wherein the recording media is further configured to record the encrypted media content without having rights established to playback the encrypted media content.

12. A television client device as recited in claim 9, wherein the recording media is further configured to record the encrypted media content from a television channel that the television client device does not have rights to render for viewing.

13. A television client device as recited in claim 9, wherein the playback application is further configured to purchase the rights to playback the encrypted media content that is recorded.

14. A television client device as recited in claim 9, wherein the decipher module is further configured to decipher the encrypted media content with the credentials.

15. A television client device as recited in claim 9, wherein the playback application is further configured to receive the credentials from the decipher module and decipher the encrypted media content.

16. A television client device as recited in claim 9, wherein the playback application is restricted from obtaining the credentials to decipher the encrypted media content for playback.

17. A media content system, comprising:
a recording device configured to record encrypted media content;
a content rendering device communicatively linked to the recording device, the content rendering device configured to receive the encrypted media content from the recording device to initiate playback of the encrypted media content; and
a decipher module configured to obtain credentials to decipher the encrypted media content when the encrypted media content is initiated for playback.

18. A media content system as recited in claim 17, wherein the recording device is further configured to record the encrypted media content without deciphering the encrypted media content.

19. A media content system as recited in claim 17, wherein the decipher module is a component of the content rendering device, the decipher module further configured to decipher the encrypted media content when it is received from the recording device for playback.

20. A media content system as recited in claim 17, wherein the decipher module is further configured to communicate the credentials to the content rendering device that deciphers the encrypted media content when it is received from the recording device for playback.
